(19) United States
(12) Patent Application Publication
(10) Pub. No.: US 2025/0019552 A1
(43) Pub. Date: Jan. 16, 2025

(54) USE OF A PAINT FORMULATION CONTAINING METALLIC EFFECT PIGMENTS FOR PAINTING A VEHICLE EQUIPPED WITH A RADAR SENSOR AND A LIDAR SENSOR

(71) Applicant: SCHLENK METALLIC PIGMENTS GMBH, Roth (DE)

(72) Inventors: Adalbert HUBER, Bencheim (DE); Matthias STÖTER, Altdorf bei Nurnberg (DE); Ralf WEBLER, Erlangen (DE)

(21) Appl. No.: 18/712,760

(22) PCT Filed: Oct. 13, 2022
(86) PCT No.: PCT/EP2022/078498

§ 371 Date: May 23, 2024

(30) Foreign Application Priority Data
Nov. 26, 2021 (EP) 21210729.6

(51) Int. Cl. C09D 7/62; C09D 5/33

(52) U.S. Cl. CPC C09D 7/62; C09D 5/004

(57) ABSTRACT

The present invention relates to the use of a paint formulation containing metallic effect pigments for painting a vehicle equipped with a radar sensor and a lidar sensor, wherein the metallic effect pigments comprise a metal substrate that is optionally passivated and enveloped with at least one dielectric layer, the metallic effect pigments having an average pigment thickness of 20 nm to 2000 nm and the relative standard deviation of the average pigment thickness being at most 40%.

The present invention relates to the use of a paint formulation containing metallic effect pigments for painting a vehicle equipped with a radar sensor and a lidar sensor.

Modern vehicles, in particular motor vehicles, are equipped with a number of sensors that make it easier to control the vehicle and at the same time are to increase the safety of the occupants. Such sensors are indispensable for self-driving motor vehicles, on which a great deal of research is being carried out. In addition to cameras that record the vehicle's surroundings in the traditional way, these are primarily radar and lidar sensors.

Radar sensors are used to detect objects in the environment, such as other vehicles or pedestrians, and to measure their distance from the vehicle and their relative speeds. Radar is the acronym for “radio detection and ranging” and means radio-based detection and distance measurement. The radar sensor is therefore a sensor based on electromagnetic radiation. Radio waves are emitted by a radiation source and the radio waves reflected from surrounding objects are registered by the radar sensor. The values measured here are converted into electrical signals, which are finally evaluated in special control devices. Radar sensors primarily work in the frequency range of 76 GHz to 81 GHz, although other frequency ranges are possible in principle.

In contrast, the lidar sensor is a sensor based on electromagnetic radiation, which uses light waves to measure distances and speeds. Lidar is the acronym for “light detection and ranging” and means light-based detection and distance measurement. The light waves emitted by a radiation source are reflected by objects in the field of view. The distance is calculated from the so-called time of fight, i.e. the time it takes for light to travel a certain distance. As with a radar sensor, the values measured are converted into electrical signals, which are finally evaluated in special control devices. Lidar sensors primarily work with near-infrared light at a wavelength of 905 nm, although other wavelengths are possible in principle.

Compared to lidar sensors, radar sensors are less sensitive to weather influences such as rain, snowfall or fog. However, slanted reflection surfaces can influence the measurement result. Modern vehicles therefore often have both radar and lidar sensors installed in order to benefit from the advantages of both sensor types. Lidar sensors must be exposed to the outside and are usually mounted on the bumper. The reason for this is that vehicle paintworks either absorb or reflect light rays, but do not transmit them. As a result, lidar sensors cannot be mounted behind panels in the vehicle, which are typically made of plastic and provided with the vehicle paintwork. Radio beams, however, can penetrate non-conductive materials such as plastic. For aesthetic reasons, radar sensors are usually mounted behind such panels in the vehicle. However, such panels, including the vehicle paintwork on them, must not be too attenuating to radio radiation.

For the most accurate detection and distance measurement possible, formulations for painting a vehicle equipped with a radar sensor and a lidar sensor must therefore have a sufficiently high radio wave transmission and at the same time a sufficiently high light wave reflectivity.

Furthermore, corresponding paint formulations must also have a specific color, also known as coloristics. Many customers want vehicle paintworks with a specified color that should appear bright and colorful at the same time. In addition to the specified color, the vehicle paintwork must also have a sufficiently high brightness and a sufficiently high chroma. Moreover, a vehicle paintwork in which the pigment contained in the paint formulation results in a metallic effect is perceived as particularly appealing. In other words, the brightness flop must also be sufficiently high. Furthermore, the vehicle paintwork requires a sufficiently high covering power. If the covering power is not sufficiently high, the paint formulation must be applied to the vehicle with a correspondingly greater layer thickness, which, in addition to higher painting costs, also leads to an increase in the weight of the vehicle. US 2018/258293 A1 describes a powder paint and a method for producing a powder paint. WO 2019/063372 A1 describes gold effect pigments with a hue in the range of 67° to 78° and chroma greater than or equal to 90. US 2003/059598 A1 describes a coating system and a method for coating a substrate with a powder coating composition, which contains a coloring effect pigment. WO 2020/208134 A1 describes a radar frequency-transparent effect pigment mixture as well as formulations and coatings thereof.

In the prior art, carbon black is often added to the paint formulations to increase their covering power. However, this comes with a loss of brightness. This also reduces the reflectivity toward light waves, which has a disadvantageous effect on the measurement accuracy of the lidar sensor. In order to achieve a sufficiently high covering power, the proportion of pigments contained in the paint formulation, which are responsible for the metallic effect, can also be increased. However, this reduces the radio wave transmission, which in turn has a negative effect on the measurement accuracy of the radar sensor. The reason for this is that the pigments contained in the paint formulation, which are responsible for the metallic effect, have a metallic core. Due to the comparatively high polarization ability of metals in electric fields, an attenuation of the radio waves occurs as their proportion increases. Pigments that do not have a metallic core and are therefore dielectric could also be used for the paint formulation. Pearlescent pigments are mentioned here as examples, which generally comprise a mica or glass substrate. However, the use of such pigments conflicts with the metallic effect. Furthermore, it is not possible to achieve sufficiently high covering power with pearlescent pigments. Carbon black must therefore be added to the corresponding paint formulations. As mentioned at the beginning, this leads to a loss of brightness and also reduces the light wave reflectivity.

In this respect, there is a need for new approaches to overcome the disadvantages described above, which occur with paint formulations from the prior art. It is therefore the object of the present invention to provide measures that meet the requirements of a paint formulation with regard to its use for painting a vehicle equipped with a radar sensor and a lidar sensor, without having a disadvantageous effect on coloristics and covering power.

The above object is achieved by the embodiments of the present invention characterized in the claims.

Thus, according to the present invention, the use of a paint formulation containing metallic effect pigments for painting a vehicle equipped with a radar sensor and a lidar sensor is provided, wherein the metallic effect pigments comprise a metal substrate that is optionally passivated and enveloped with at least one dielectric layer, the metallic effect pigments having an average pigment thickness of 20 nm to 2000 nm and the relative standard deviation of the average pigment thickness being at most 40%.

The paint formulation used according to the present invention allows cost-effective painting of a vehicle equipped with a radar sensor and a lidar sensor, the vehicle paintwork resulting from the paint formulation not only having a sufficiently high light wave reflectivity and a sufficiently high radio wave transmission, but also being characterized by a sufficiently high brightness and a sufficiently high chroma with a sufficiently high brightness flop and at the same time a sufficiently high covering power. This is due to the metallic effect pigments contained in the paint formulation, which have specific geometric properties.

According to the present invention, the paint formulation contains metallic effect pigments. In contrast to pearlescent pigments with their mica or glass substrate, metallic effect pigments comprise a metal substrate. Metallic effect pigments thus have a metallic core. Because of this, a higher covering power can be achieved with metallic effect pigments compared to pearlescent pigments. If necessary, the metal substrate is passivated. For example, it can be covered with a native oxide layer.

As far as the material is concerned, the metal substrate is not further limited here. For example, the metal substrate can be made of metals such as iron, aluminum, copper, nickel, chromium, zinc, tin, silver, gold, platinum, cobalt, lanthanides and titanium, as well as mixtures or alloys thereof, including steel, in particular stainless steel. In a preferred embodiment, the metal substrate is made of aluminum.

According to the present invention, the metal substrate is enveloped with at least one dielectric layer. In general, it is sufficient if only part of the surface of the metal substrate is covered with the at least one dielectric layer. For example, only one of the two main surfaces of the metal substrate may be covered with the at least one dielectric layer. In addition, the side surfaces of the metal substrate can also be left out. According to the present invention, however, the entire surface of the optionally passivated metal substrate is covered with the at least one dielectric layer, which is why we are also talking about enveloping here. This does not only contribute to an improvement in the coloristics, but also increases the mechanical and chemical resistance of the metallic effect pigments. If more than one dielectric layer is present, each dielectric layer envelops the underlying dielectric layer and the underlying metal substrate.

The at least one dielectric layer is made of a dielectric. As a rule, these are (semi-)metal oxides such as silicon dioxide (SiO₂) or aluminum oxide (Al₂O₃), which are considered to be low-refractive with a refractive index of n≤1.8, and (semi-) metal oxides such as iron (III) oxide (Fe₂O₃), titanium (IV) oxide (TiO₂), tin (IV) oxide (SnO₂), chromium (III) oxide (Cr₂O₃) or cobalt (III) oxide (Co₂O₃), which are considered to be high-refractive with a refractive index of n>1.8, but without being limited to this. For example, other low- and/or high-refractive dielectrics can also be used. By appropriately selecting the dielectric of the at least one dielectric layer, a desired hue can be set, wherein in addition to the refractive index of the dielectric, its layer thickness also has an influence on the coloristics. If the layer thickness of the at least one dielectric layer is set appropriately, interference occurs in the visible spectral range, caused by the reflection of the incident light at the interfaces of the at least one dielectric layer. In the case of such metallic effect pigments, which are also referred to as interference pigments, the layer thickness of the at least one dielectric layer is typically at least 20 nm. The high-refractive dielectrics are largely responsible for the interference and thus also for the coloristics.

To set a desired color, a single dielectric layer can also be made of different (high-refractive) dielectrics. A dielectric layer made of iron (III) oxide and titanium (IV) oxide is mentioned here as an example. It is basically referred to as a mixed layer.

In interference pigments, the metal substrate contributes to the interference due to the reflection that takes place on the substrate surface, which is naturally not the case with pearlescent pigments with their mica or glass substrate.

The at least one dielectric layer can be applied to the optionally passivated metal substrate by hydrolytic decomposition of suitable precursor compounds, such as tetraethyl orthosilicate (Si(OC₂H₅)₄), iron (III) chloride (FeCl₃) or iron (III) nitrate (Fe(NO₃)₃), if necessary with subsequent tempering. The at least one dielectric layer can also be applied by gas phase decomposition of a suitable precursor compound, such as di-tert-butoxy-diacetoxysilane (Si(OC(CH₃)₃)₂ (OCOCH₃)₂) or iron pentacarbonyl (Fe(CO)₅). The relevant procedure is well known to those skilled in the art from the prior art.

In EP 1 114 103 B1, for example, a dielectric layer made of silicon dioxide using sodium silicate is first applied to a metal substrate made of aluminum. Subsequently, a wet chemical coating is carried out with iron (III) oxide using iron (III) chloride. Furthermore, the coating with titanium (IV) oxide and tin (IV) oxide is described in EP 1 114 103 B1. From EP 0 708 154 B1 there is known a production method that uses a combination of hydrolytic decomposition and gas phase decomposition to apply the dielectric layers. A metal substrate made of aluminum is first wet-chemically coated with silicon dioxide using ammonia as a base, with tetraethyl orthosilicate serving as the precursor compound. After drying the metal substrate coated in this way, the coating with iron (III) oxide takes place in a fluidized bed reactor, with iron pentacarbonyl serving as a precursor compound. Alternatively, both dielectric layers can also be applied in the fluidized bed reactor, in which case, in addition to iron pentacarbonyl, di-tert-butoxy-diacetoxysilane serves as a precursor compound. Finally, from WO 2013/175339 A1 there is known a purely wet chemical process for coating metal substrates made of aluminum with iron (III) oxide using iron (III) nitrate. Purely wet chemical processes are also described in WO 2015/014484 A1 and WO 2020/038684 A1.

In a specific embodiment, the metallic effect pigments comprise an optionally passivated metal substrate made of aluminum, which is coated with a dielectric layer of silicon dioxide and with a dielectric layer of iron (III) oxide in this order. Instead of the dielectric layer made of iron (III) oxide, a dielectric layer made of iron (III) oxide and titanium (IV) oxide, i.e. a mixed layer, can also be applied to the dielectric layer made of silicon dioxide. In addition, the corresponding low- and high-refractive dielectric layers can also be applied alternately to the metal substrate.

If required, the metallic effect pigments can be provided with a surface coating. Without being limited to this, the surface coating may be made of organic polymers, silanes or siloxanes. By applying such a surface coating to the at least one dielectric layer, which is also referred to as surface functionalization, the mechanical and chemical resistance of the metallic effect pigments can be further increased. The respective procedure is described in detail in WO 2015/044188 A1 and EP 2 318 463 B1, among others.

According to the present invention, the metallic effect pigments have an average pigment thickness of 20 nm to 2000 nm, preferably 50 nm to 1700 nm, and even more preferably 200 nm to 1500 nm. In the present case, the term “pigment thickness” means the thickness of the entire metallic effect pigment, i.e. including the thickness of the at least one dielectric layer and the thickness of a surface coating that may have been applied thereto.

The average pigment thickness is determined by measuring based on scanning electron microscope (SEM) images. The procedure is as follows: The metallic effect pigments, which are in powder form, are dispersed in a nitrocellulose-based paint and applied to an aluminum foil. The mixing ratio between powder and paint in the liquid system is 1:10. A section of 1 cm² of the aluminum foil painted in this way is cut out to create a cross section using a broad beam ion source by irradiation with high-energy Ar ions. To ensure sufficient conductivity, the cut-out cross section is sputtered with a nm thin carbon layer. The metallic effect pigments are then imaged in cross section using a scanning electron microscope at magnifications in the range of 10,000× to 30,000×. The pigment thickness is determined from at least 500 different metallic effect pigments. The average pigment thickness then represents the arithmetic number average of the determined pigment thicknesses.

The relative standard deviation of the average pigment thickness according to the present invention is at most 40%, preferably at most 20%, and even more preferably at most 10%. The relative standard deviation, also known as the coefficient of variation, relates the absolute standard deviation to the average pigment thickness determined from at least 500 different metallic effect pigments. The relative standard deviation of the average pigment thickness is therefore a measure of the variation in thickness of the metallic effect pigments. The smaller the relative standard deviation, the smaller the variation in thickness of the metallic effect pigments.

As far as the size of the metallic effect pigments, i.e. their pigment diameter, is concerned, the present invention is not further restricted. Typically, the metallic effect pigments have a pigment diameter d₅₀ in the range of 3 μm to 100 μm, for example in the range of 5 μm to 50 μm, or in the range of 10 μm to 30 μm. The pigment diameter in this case is the so-called d₅₀. It indicates the value at which 50% of the metallic effect pigments from a sample are smaller than the specified value. Here too, at least 500 different metallic effect pigments serve as a sample.

The pigment diameter d₅₀ is determined by measuring based on laser light diffraction in accordance with DIN ISO 13320:2020-01 using a commercially available particle size analyzer from the company Sympatec GmbH, Clausthal-Zellerfeld, Germany.

The aspect ratio of the metallic effect pigments can finally be determined from the average pigment thickness and the pigment diameter d₅₀. The aspect ratio, i.e. the ratio of pigment diameter d₅₀ to average pigment thickness, is preferably at least 3:1, for example at least 4:1, or at least 5:1. A large aspect ratio promotes the alignment of the metallic effect pigments upon application of the paint formulation to the surface of the vehicle, which has a particularly advantageous effect on the covering power of the vehicle paintwork resulting from the paint formulation.

Due to the above specific geometric properties of the metallic effect pigments, the vehicle paintwork resulting from the paint formulation has, in addition to a sufficiently high light wave reflectivity and a sufficiently high radio wave transmission, also a sufficiently high brightness and a sufficiently high chroma with a sufficiently high brightness flop and at the same time a sufficiently high covering power. As the inventors surprisingly discovered, this is particularly due to the low variation in thickness, expressed by a relative standard deviation of the average pigment thickness of at most 40%, preferably at most 20%, and even more preferably at most 10%, of the metallic effect pigments contained in the paint formulation.

Since the at least one dielectric layer can be applied to the metal substrate with high precision in terms of its layer thickness, the variation in thickness of the metallic effect pigments depends primarily on the variation in thickness of the metal substrates used in their production. In the case of metal substrates with a low variation in thickness, metallic effect pigments with a low variation in thickness are consequently also obtained after the at least one dielectric layer has been applied. This also applies if another surface coating is applied to the at least one dielectric layer. Conversely, metal substrates with a large variation in thickness lead to metallic effect pigments with a large variation in thickness. Differences in the thickness of the metal substrates are, to a certain extent, transferred to the at least one dielectric layer applied thereto and the surface coating optionally applied thereto.

In order to meet the relative standard deviation of the average pigment thickness of at most 40%, preferably at most 20%, and even more preferably at most 10%, metal substrates with the smallest possible variation in thickness must therefore be used in the production of the metallic effect pigments.

Metal substrates with the smallest possible variation in thickness can be obtained, for example, by vacuum metallization. Vacuum metallization is a special form of physical vapor deposition, abbreviated as PVD. For this purpose, a carrier film is vapor-deposited with a metal such as aluminum in a high vacuum in order to produce a thin metal layer with a thickness in the nanometer range on the carrier film. The metal layer is then removed from the carrier film with the help of solvents, wherein it is comminuted into platelets by the shear forces that occur. To make detachment easier, a release coating can be applied to the carrier film before vapor deposition. Metal substrates obtained by vacuum metallization are characterized by a particularly small thickness. Accordingly, their variation in thickness is also particularly low, which is why metallic effect pigments produced from this satisfy the relative standard deviation of the average pigment thickness of at most 40%, preferably at most 20%, and even more preferably at most 10%.

In contrast, metal substrates that are obtained by wet grinding have a significantly more pronounced variation in thickness, which in turn leads to a significantly larger relative standard deviation of the average pigment thickness. According to their appearance, metal substrates obtained by wet grinding are also referred to as “cornflakes” or “silver dollars”. While metal substrates of the “cornflake” type, which is also referred to as the lamellar type, have irregular and jagged side edges, they are usually rounded in metal substrates of the “silver dollar” type, which is also referred to as the lenticular type. Metal substrates obtained by vacuum metallization, which are also referred to as “vacuum metallized pigments”, abbreviated as VMPs, are polygons with straight side edges. In addition to their particularly low variation in thickness, they also have a significantly smoother surface compared to metal substrates of the “cornflake” type type and of the “silver dollar” type. In a preferred embodiment, the metal substrate is a metal substrate obtained by vacuum metallization.

The paint formulation, as used according to the present invention for painting a vehicle equipped with a radar sensor and a lidar sensor, may contain a mixture of two or more of the metallic effect pigments. If metallic effect pigments are mentioned in the present case, what is meant are those that have the above specific geometric properties, in particular a low variation in thickness. By using a mixture of two or more of the metallic effect pigments, also those hues can be achieved that cannot easily be obtained by using just a single metallic effect pigment. For this purpose, the paint formulation can also contain at least one other pigment in addition to the metallic effect pigments, including mica- or glass-based pearlescent pigments. However, the pigments contained in the paint formulation can also be limited to metallic effect pigments, i.e. the paint formulation then contains no other pigments in addition to the metallic effect pigments. In particular, the paint formulation preferably does not contain organic or inorganic absorption pigments such as carbon black or at most a small proportion thereof. As already mentioned at the beginning, the addition of carbon black is accompanied by a loss of brightness. The light wave reflectivity is also reduced, which has a negative impact on the measurement accuracy of the lidar sensor. Due to their sufficiently high covering power, which will be discussed in more detail below, the addition of carbon black or the like in the paint formulation as used according to the present invention is not required, or at most only to a small extent.

Apart from the pigments, the paint formulation contains a binder and a solvent, and other components such as fillers and/or auxiliaries may also be contained in the paint formulation. Typical binders and solvents as well as fillers and auxiliaries of any kind are known to those skilled in the art. Platelets made of calcium carbonate (CaCO₃) are mentioned here as an exemplary filler. Examples of auxiliaries include defoamers, wetting agents, light stabilizers and leveling agents.

By evaporating the solvent after applying the paint formulation to the surface of the vehicle, the vehicle paintwork is finally created from the paint formulation. The application of the paint formulation is not limited to a particular method. It is expediently carried out by spraying or spraying with a pressure atomizer, wherein the layer thickness of the vehicle paintwork resulting from the paint formulation can be adjusted via the duration of the application. Since the paint formulation leads to a sufficiently high covering power, a comparatively small layer thickness is sufficient for vehicle paintwork. Typical layer thicknesses are in the range of 10 μm to 30 μm, although smaller layer thicknesses are also possible as long as the covering power is sufficiently high. A layer thickness of 14 μm is mentioned here as an example. The layer thickness here always means the layer thickness of the vehicle paintwork, which is reduced compared to the layer thickness of the paint formulation by drying the solvent contained therein and optionally by filming.

The pigment mass concentration of the metallic effect pigments in the paint formulation is typically in the range of 1% by mass to 15% by mass, but is not limited to this. The pigment mass concentration means the mass fraction of the metallic effect pigments in relation to the total dry mass of the paint formulation. In addition to the mass of the metallic effect pigments, the total dry mass includes the mass of all other non-volatile components. The following applies: the greater the pigment mass concentration, the higher the covering power with the same layer thickness of the vehicle paintwork.

The paint formulation, as used according to the present invention for painting a vehicle equipped with a radar sensor and a lidar sensor, has a sufficiently high covering power. Typically, with a 14 μm layer thickness of the vehicle paintwork resulting from the paint formulation and with a pigment mass concentration of the metallic effect pigments in the paint formulation in the range of 1% by mass to 15% by mass, the color distance ΔE110° is at most 1.5, preferably at most 1.2. and even more preferably at most 1.0. The color distance ΔE110° is a measure of the covering power, with a smaller color distance meaning a higher covering power. In this case, paintwork with a color distance ΔE110° of a maximum of 1.5 is described as opaque.

To determine the covering power, the paint formulation is applied to a black and white panel so that the vehicle paintwork resulting from the paint formulation has a layer thickness of 14 μm. The color distance between black and white is then measured in the geometry 45°/110° in accordance with DIN 6175:2019-07 using a commercially available multi-angle spectrophotometer.

The hue of the vehicle paintwork resulting from the paint formulation depends primarily on the color characteristics of the metallic effect pigments contained in the paint formulation, but can be influenced by the addition of other pigments, such as mica- or glass-based pearlescent pigments as well as organic or inorganic absorption pigments. This also applies to the brightness and chroma as well as the brightness flop. Exemplary values for the hue Hᵤᵥ 15°, which is also referred to as the hue angle, are in the range of 25 to 50, which is typical for red, orange or gold tones. However, the hue is by no means limited to this. Accordingly, the hue angle can also lie outside the range of 25 to 50. As far as brightness and chroma are concerned, the lightness L*15° is typically at least 100 and the chroma Cᵤᵥ 15° is typically at least 150. The brightness flop, expressed as the Alman flop index FI, is typically at least 20.

To determine the hue, brightness, chroma and brightness flop, the paint formulation is applied to a black background. The spectral reflection of a light beam incident on the measuring surface at an angle of 45° and emitted by a D65 light source is then measured at six different detection angles (−15°, 15°, 25°, 45°, 75° and) 110° for a 10° observer in accordance with DIN EN ISO 18314-3:2018-12 with a commercially available multi-angle spectrophotometer and converted into the corresponding variables of the CIELAB and CIEHLC color space. The commercially available multi-angle spectrophotometer used here is the device “BYK-mac i MetallicColour” from the company BYK-Gardner GmbH, Geretsried, Germany, which is also used to determine the color distance ΔE110°. The Alman flop index FI is calculated in accordance with A. B. J. Rodrigues, “Metallic flop and its measurement”, J. Oil Color Chem. Assoc. 1992, 75 (4), 150-153.

The paint formulation, as used according to the present invention for painting a vehicle equipped with a radar sensor and a lidar sensor, has a sufficiently high light wave reflectivity and a sufficiently high radio wave transmission. In the present case, the dielectric constant, which is also referred to as permittivity ε, is used to characterize the radio wave transmission, as is also described in F. Pfeiffer, “Analyse und Optimierung von Radomen für automobile Radarsensoren”, dissertation, Technical University of Munich, 2009. The smaller the permittivity ε, the less the radio waves are attenuated. Typically, the vehicle paintwork resulting from the paint formulation has a permittivity ε of at most 30, preferably at most 20, and even more preferably at most 10 in the frequency range of 76 GHz to 81 GHz. With such permittivity, the paint formulation is particularly suitable for use in painting a vehicle equipped with a radar sensor. In addition, the vehicle paintwork resulting from the paint formulation typically has a reflectivity R of at least 50%, preferably at least 60%, and even more preferably at least 70% at a wavelength of 905 nm. With such reflectivity, the paint formulation is particularly suitable for use in painting a vehicle that is equipped with a lidar sensor.

The permittivity ε in the frequency range of 76 GHz to 81 GHz is determined using a commercially available Radome scanner. After calibration, the polycarbonate measuring plates used, which have a thickness of 2 mm, are measured before and after application of the paint formulation. In both cases, the radio beams are irradiated perpendicular to the surface of the measuring plates. The permittivity ε can finally be determined from the measured values, whereby it is constant over the frequency range selected in the present case. The commercially available Radome scanner used here is the device “Radome Measurement System” from the company perisens GmbH, Feldkirchen near Munich, Germany. The reflectivity R is determined in an analogous manner at a wavelength of 905 nm by irradiating the light waves perpendicular to the measuring surface.

The paint formulation can advantageously be used for painting motor vehicles, in particular self-propelled motor vehicles, which are equipped with a radar sensor and a lidar sensor. In principle, however, any vehicle can be painted with the paint formulation used according to the present invention.

The paint formulation used according to the present invention allows the cost-effective painting of a vehicle equipped with a radar sensor and a lidar sensor, the vehicle paintwork resulting from the paint formulation not only having a sufficiently high light wave reflectivity and a sufficiently high radio wave transmission, but also being characterized by a sufficiently high brightness and a sufficiently high chroma with a sufficiently high brightness flop and at the same time a sufficiently high covering power. The paint formulation used according to the present invention therefore satisfies the requirements of a paint formulation with regard to its use for painting a vehicle equipped with a radar sensor and a lidar sensor, without having a disadvantageous effect on coloristics and covering power.

### EXAMPLES

The following examples serve to further illustrate the present invention, but are not limited thereto.

Paint formulations with the metallic effect pigments listed in Table 1, referred to as pigments a to e, all of which are commercially available, were prepared.

Pigments a and b are from the company Schlenk Metallic Pigments GmbH, Roth, Germany, and pigments c, d and e are from the company BASF Colors ε Effects GmbH, Ludwigshafen, Germany. The metallic effect pigments are listed in Table 1 together with the average pigment thickness and the absolute standard deviation of the average pigment thickness, determined in accordance with the aforementioned measurement method, as well as with the relative standard deviation of the average pigment thickness obtainable therefrom. The metallic effect pigments of Table 1 all include a metal substrate made of aluminum. In the case of pigments a and b, the aluminum metal substrate is obtained by vacuum metallization, whereas in the case of pigments c, d and e it is obtained by wet milling. In pigments c and d, the aluminum metal substrate is of the “cornflake” type, whereas in pigment e it is of the “silver dollar” type.

TABLE 1

| | | | Absolute | Relative |
|---|---|---|---|---|
| | | | standard | standard |
| | | | deviation of | deviation of |
| | | Average | average | average |
| | | pigment | pigment | pigment |
| | | thickness | thickness | thickness |
| Pigment | | (nm) | (nm) | (%) |
| a | Zenexo ® WB 21 OO | 335 | 19 | 5.7 |
| b | Zenexo ® WB 21 YY | 327 | 20 | 6.1 |
| c | Paliocrom ® L2800 | 338 | 188 | 55.6 |
| d | Paliocrom ® L2020 | 297 | 202 | 68.0 |
| e | Paliocrom ® L2854 | 434 | 230 | 53.0 |

To prepare the paint formulations, the metallic effect pigments of Table 1 were dispersed in a paint system (single-component paint based on cellulose acetobutyrate, containing solvent). In the respective paint formulations, the metallic inference pigments used were present either individually as a pure hue or as a mixture and, optionally, together with a carbon black paste (Helio Beit® UN 907 from the company Helio Beit Pigmentpasten GmbH, Cologne, Germany) and/or a red pigment paste (Hostatint® Red A-P2Y 100-ST from the company Clariant AG, Muttenz, Switzerland) as a further pigment or pigments.

After preparing the paint formulations, they were sprayed onto the polycarbonate measuring plates so that after the solvent had evaporated, paints with a layer thickness of 14 μm were obtained. The paintworks were then examined in more detail with regard to their radio wave transmission and light wave reflectivity as well as with regard to their coloristics and covering power. The corresponding variables were determined in accordance with the measurement methods mentioned above.

### Examples 1 to 4

Paintwork with Orange Shade in the Hue Angle Range Hᵤᵥ 15° from 33 to 35

Table 2 shows for the respective paintworks, in addition to the pigment mass concentration PMK_{Pigment} of the metallic effect pigments used, also the pigment mass concentration PMK_{w.Pigment} of the further pigment, if present. In addition, Table 2 includes for the respective paintworks the determined values for the permittivity ε in the frequency range of 76 GHz to 81 GHZ, the reflectivity R at a wavelength of 905 nm, the hue Hᵤᵥ 15°, the brightness L*15°, the chroma Cᵤᵥ 15°, the Alman flop index FI, and the color distance ΔE110°.

TABLE 2

| | | PMK_{Pigment} | PMK_{w.Pigment}* | | R | | | | | |
|---|---|---|---|---|---|---|---|---|---|---|
| Ex. | Pigment | (mass-%) | (mass-%) | ε | (%) | Hᵤᵥ15° | L*15° | Cᵤᵥ15° | FI | ΔE110° |
| 1 | a | 12 | — | 30.0 | 55.6 | 34.8 | 110.6 | 192.8 | 24.5 | 1.5 |
| 2 | c | 12 | — | 30.0 | 49.4 | 33.2 | 94.0 | 172.7 | 17.1 | 2.4 |
| 3 | c | 13.42 | — | 34.4 | 50.6 | 33.2 | 95.0 | 172.6 | 16.9 | 1.5 |
| 4 | c | 12 | 0.138 | 29.6 | 47.4 | 33.3 | 96.0 | 164.6 | 17.2 | 1.5 |

*The above-mentioned black carbon paste served as a further pigment here.

The hue angle Hᵤᵥ 15° in the range of 33 to 35, which corresponds to an orange shade, came almost exclusively from the metallic effect pigments used.

In Example 1 with pigment a, a pigment mass concentration of PMK_{Pigment} of 12% by mass was required to achieve an opaque state with a layer thickness of 14 μm.

In Example 2 with pigment c (not according to the invention), the pigment mass concentration PMK_{Pigment} was also 12% by mass with the same layer thickness. However, no opaque state was achieved. The Alman flop index FI was also reduced.

In Example 3 with pigment c (not according to the invention), the pigment mass concentration PMK_{Pigment} was increased to 13.42% by mass with the same layer thickness, so that an opaque state was achieved. However, this increased the permittivity ε in the frequency range of 76 GHz to 81 GHz to a value of over 30.

In contrast, in Example 4 with pigment c (not according to the invention), black carbon paste was added to achieve an opaque state. However, as can be seen from a comparison with Example 1, this came at the expense of coloristics. As a result, the reflectivity R at a wavelength of 905 nm dropped to a value of less than 50%.

Based on Examples 1 to 4, it can be concluded that only with the paint formulation containing pigment a can a vehicle paintwork be obtained which, in addition to a sufficiently high light wave reflectivity and a sufficiently high radio wave transmission, is also characterized by a sufficiently high brightness and a sufficiently high chroma with a sufficiently high brightness flop and at the same time a sufficiently high covering power.

### Examples 5 to 8

Paintwork with Orange Shade in the Hue Angle Range Hᵤᵥ 15° from 33 to 35

Table 3 shows for the respective paintworks, in addition to the pigment mass concentration PMK_{Pigment} of the metallic effect pigments used, also the pigment mass concentration PMK_{w.Pigment} of the further pigment, if present. In addition, for the respective paintworks, Table 3 includes the determined values for the permittivity ε in the frequency range of 76 GHz to 81 GHZ, the reflectivity R at a wavelength of 905 nm, the hue Hᵤᵥ 15°, the brightness L*15°, the chroma Cᵤᵥ 15°, the Alman flop index FI, and the color distance ΔE110°.

TABLE 3

| | | PMK_{Pigment} | PMK_{w.Pigment}* | | R | | | | | |
|---|---|---|---|---|---|---|---|---|---|---|
| Ex. | Pigments | (mass-%) | (mass-%) | ε | (%) | Hᵤᵥ15° | L*15° | Cᵤᵥ15° | FI | ΔE110° |
| 5 | a | 12 | — | 30.0 | 55.6 | 34.8 | 110.6 | 192.8 | 24.5 | 1.5 |
| 6 | e | 12 | — | 18.0 | 47.4 | 33.4 | 93.0 | 174.0 | 19.3 | 16.1 |
| 7 | e | 19.03 | — | 32.2 | 56.8 | 33.4 | 100.2 | 110.7 | 18.0 | 0.4 |
| 8 | e | 11.16 | 0.657 | 17.0 | 36.0 | 33.8 | 80.3 | 137.3 | 21.6 | 1.5 |

*The above-mentioned black carbon paste served as a further pigment here.

The hue angle Hᵤᵥ 15° in the range of 33 to 35, which corresponds to an orange shade, came almost exclusively from the metallic effect pigments used.

In Example 5 with pigment a, a pigment mass concentration of PMK_{Pigment} of 12% by mass was required to achieve an opaque state with a layer thickness of 14 μm. Example 5 is identical to Example 1.

In Example 6 with pigment e (not according to the invention), the pigment mass concentration PMK_{Pigment} was also 12% by mass with the same layer thickness. However, no opaque state was achieved. The Alman flop index FI was also reduced.

In Example 7 with pigment e (not according to the invention), the pigment mass concentration PMK_{Pigment} was increased to 19.03% by mass with the same layer thickness, so that an opaque state was achieved. However, this increased the permittivity ε in the frequency range of 76 GHz to 81 GHz to a value of over 30.

In contrast, in Example 8 with pigment e (not according to the invention), black carbon paste was added to achieve an opaque state. However, as can be seen from a comparison with Example 5, this came at the expense of coloristics. As a result, the reflectivity R at a wavelength of 905 nm dropped to a value of less than 50%.

Based on Examples 5 to 8, it can be concluded that only with the paint formulation containing pigment a can a vehicle paintwork be obtained which, in addition to a sufficiently high light wave reflectivity and a sufficiently high radio wave transmission, is also characterized by a sufficiently high brightness and a sufficiently high chroma with a sufficiently high brightness flop and at the same time a sufficiently high covering power.

### Examples 9 to 12

Paintwork with Gold Shade in the Hue Angle Range Hu 15° from 47 to 48

Table 4 shows for the respective paintworks, in addition to the pigment mass concentration PMK_{Pigment} of the metallic effect pigments used, also the pigment mass concentration PMK_{w.Pigment} of the further pigment, if present. In addition, for the respective paintworks, Table 4 includes the determined values for the permittivity ε in the frequency range of 76 GHz to 81 GHZ, the hue Hᵤᵥ 15°, the brightness L*15°, the chroma Cᵤᵥ 15°, the Alman flop index FI, and the color distance ΔE110°.

TABLE 4

| | | PMK_{Pigment} | PMK_{w.Pigment}* | | R | | | | |
|---|---|---|---|---|---|---|---|---|---|
| Ex. | Pigments | (mass-%) | (mass-%) | ε | (%) | Hᵤᵥ15° | L*15° | Cᵤᵥ15° | FI |
| 9 | a and b | 6.865 | — | 30.0 | 47.5 | 127.1 | 150.6 | 28.1 | 1.2 |
| 10 | d | 6.865 | — | 22.0 | 47.8 | 104.9 | 119.8 | 17.4 | 5.3 |
| 11 | d | 11.637 | — | 48.0 | 47.8 | 108.8 | 124.4 | 16.1 | 1.2 |
| 12 | d | 6.865 | 0.196 | 22.0 | 47.7 | 95.3 | 109.9 | 17.1 | 1.2 |

*The above-mentioned black carbon paste served as a further pigment here.

The hue angle Hᵤᵥ 15° in the range of 47 to 48, which corresponds to a gold shade, came almost exclusively from the metallic effect pigments used.

In Example 9 with pigments a and b, a pigment mass concentration of PMK_{Pigment} Of 6.865% by mass was required to achieve an opaque state with a layer thickness of 14 μm. Pigments a and b were present in a mass ratio of 50:50.

In Example 10 with pigment d (not according to the invention), the pigment mass concentration PMK_{Pigment} was also 6.865% by mass with the same layer thickness. However, no opaque state was achieved. The Alman flop index FI was also reduced.

In Example 11 with pigment d (not according to the invention), the pigment mass concentration PMK_{Pigment} was increased to 11.637% by mass with the same layer thickness, so that an opaque state was achieved. However, this increased the permittivity ε in the frequency range of 76 GHz to 81 GHz to a value of over 30.

In contrast, in Example 12 with pigment d (not according to the invention), black carbon paste was added to achieve an opaque state. However, as can be seen from a comparison with Example 9, this came at the expense of coloristics.

Based on Examples 9 to 12, it can be concluded that only with the paint formulation containing pigments a and b can a vehicle paintwork be obtained which, in addition to a sufficiently high light wave reflectivity and a sufficiently high radio wave transmission, is also characterized by a sufficiently high brightness and a sufficiently high chroma with a sufficiently high brightness flop and at the same time a sufficiently high covering power.

### Examples 13 to 16

Paintwork with Red Shade in the Hue Angle Range Hᵤᵥ 15° from 27 to 28

Table 5 shows for the respective paintworks, in addition to the pigment mass concentration PMK_{Pigment} of the metallic effect pigments used, also the pigment mass concentration PMK_{w.Pigment} of the further pigment(s), if present. In addition, for the respective paintworks, Table 5 includes the determined values for the permittivity ε in the frequency range of 76 GHz to 81 GHZ, the reflectivity R at a wavelength of 905 nm, the hue Hᵤᵥ 15°, the brightness L*15°, the chroma Cᵤᵥ 15°, the Alman flop index FI, and the color distance ΔE110°.

TABLE 5

| | | PMK_{Pigment} | PMK_{w.Pigment}* | | | R | | | | | |
|---|---|---|---|---|---|---|---|---|---|---|---|
| Ex. | Pigments | (mass-%) | (mass-%) | | ε | (%) | Hᵤᵥ15° | L*15° | Cᵤᵥ15° | FI | Ex. |
| 13 | a | 12.052 | — | 1.65 | 30.0 | 55.0 | 27.5 | 99.7 | 206.9 | 25.2 | 1.3 |
| 14 | a | 8.683 | 0.256 | 1.686 | 20.0 | 46.7 | 27.5 | 91.8 | 190.0 | 27.0 | 1.5 |
| 15 | e | 13.186 | 0.501 | 1.515 | 20.0 | 40.6 | 27.5 | 76.9 | 154.2 | 21.2 | 1.3 |
| 16 | c | 6.538 | 0.594 | 1.416 | 14.0 | 34.9 | 27.5 | 70.0 | 142.7 | 20.0 | 1.3 |

*The above-mentioned black carbon paste and the above-mentioned red pigment paste served as further pigments here. The values in the left half of the column each represent the pigment mass concentration of the black carbon paste, while the values in the right half of the column each represent the pigment mass concentration of the red pigment paste.

The hue angle Hᵤᵥ 15° in the range of 27 to 28, which corresponds to a red shade, came from the combination of the metallic effect pigments used with the red pigment paste.

In Example 13 with pigment a, a pigment mass concentration of PMK_{Pigment} of 12.052% by mass was required to achieve an opaque state with a layer thickness of 14 μm.

In Example 14 with pigment a, the pigment mass concentration PMK_{Pigment} Was reduced with the same layer thickness. In order to achieve an opaque condition, carbon black paste was added. However, as can be seen from a comparison with Example 13, this came at the expense of coloristics. As a result, the reflectivity R at a wavelength of 905 nm also dropped to a value of less than 50%.

In Example 15 with pigment e (not according to the invention) and Example 16 with pigment c (not according to the invention), considerably more carbon black paste had to be added with the same layer thickness in order to achieve an opaque state. However, as can be seen from a comparison with Example 13, this came at the expense of coloristics. As a result, the reflectivity R at a wavelength of 905 nm also dropped to a value of less than 50%.

Based on Examples 13 to 16, it can be concluded that only with the paint formulation containing pigment a can a vehicle paintwork be obtained which, in addition to a sufficiently high light wave reflectivity and a sufficiently high radio wave transmission, is also characterized by a sufficiently high brightness and a sufficiently high chroma with a sufficiently high brightness flop and at the same time a sufficiently high covering power.

1. A method of painting a vehicle equipped with a radar sensor and lidar sensor comprising applying a paint formulation to a surface of a vehicle having a radar sensor and a lidar sensor, the paint formulation containing metallic effect pigments, wherein the metallic effect pigments comprise a metal substrate that is optionally passivated and enveloped with at least one dielectric layer, the metallic effect pigments having an average pigment thickness of 20 nm to 2000 nm and the relative standard deviation of the average pigment thickness being at most 40%.

2. The method according to claim 1, wherein the metal substrate is made of aluminum.

3. The method according to claim 1, wherein the at least one dielectric layer is of a dielectric selected from silicon dioxide, aluminum oxide, iron (III) oxide, titanium (IV) oxide, tin (IV) oxide, chromium (III) oxide, and cobalt (III) oxide.

4. The method according to claim 1, wherein the metallic effect pigments are interference pigments.

5. The method according to claim 1, wherein the metallic effect pigments are provided with a surface coating.

6. The method according to claim 1, wherein the relative standard deviation of the average pigment thickness is at most 10%.

7. The method according to claim 1, wherein the metallic effect pigments have a pigment diameter d₅₀ in the range of 3 μm to 100 μm.

8. The method according to claim 1, wherein the metal substrate is a metal substrate obtained by vacuum metallization.

9. The method according to claim 1, wherein the paint formulation contains a mixture of two or more of the metallic effect pigments.

10. The method according to claim 1, wherein the paint formulation contains at least one further pigment in addition to the metallic effect pigments.

11. The method according to claim 1, wherein the paint formulation does not contain any carbon black.

12. The method according to claim 1, wherein with a 14 μm layer thickness of the vehicle paint resulting from the paint formulation and with a pigment mass concentration of the metallic effect pigments in the paint formulation in the range of 1% by mass to 15% by mass, the color distance ΔE110° is at most 1.5.

13. The method according to claim 12, wherein the vehicle paintwork resulting from the paint formulation has a hue Hᵤᵥ 15° in the range of 25 to 50, a brightness L*15° of at least 100, a chroma Cᵤᵥ 15° of at least 150, and an Alman flop Index FI of at least 20.

14. The method according to claim 12, wherein the vehicle paintwork resulting from the paint formulation has a permittivity ε of at most 30 in the frequency range of 76 GHz to 81 GHz and a reflectivity R of at least 50% at a wavelength of 905 nm.

15. The method according to claim 1, wherein the vehicle is a motor vehicle, in particular a self-propelled motor vehicle.
